(19) United States
(12) Patent Application Publication
(10) Pub. No.: US 2015/0245735 A1
(43) Pub. Date: Sep. 3, 2015

(54) DEVICE FOR PREPARING MILK FROTH THAT CAN BE OPTIONALLY HOT OR COLD, OR FOR DISPENSING OPTIONALLY HOT OR COLD MILK

(71) Applicant: EUGSTER/FRISMAG AG, Amriswil (CH)

(72) Inventor: Dieter Stutz, Bussnang (CH)

(73) Assignee: Eugster/Frismag AG, Amriswil (CH)

(21) Appl. No.: 14/430,015

(22) PCT Filed: Sep. 23, 2013
(86) PCT No.: PCT/EP2013/002855

§ 371 Date: Mar. 20, 2015

(30) Foreign Application Priority Data
Sep. 21, 2012 (DE) 20 2012 009 076.3

(51) Int. Cl. A47J 31/44; A47J 31/60; A47J 31/46

(52) U.S. Cl. CPC A47J 31/4485; A47J 31/46; A47J 31/60

(57) ABSTRACT

The invention relates to a device for preparing milk froth that can be optionally hot or cold, or for dispensing optionally hot or cold milk (1), said device comprising a milk container (4) that can be removed from the device, a milk inlet which connects the milk container (4) to a cold froth device via a milk valve section, said cold froth device being activatable by means of an air valve section; and an outlet line (15) located downstream of the cold froth device and comprising an outlet (16). The milk container (4) can be inserted into the device (1) in a guided manner and the base (4a) of said container is equipped with a milk snap-in valve (17). A complementary receiving section (17a) for the milk snap-in valve, said section being fixed in the device (1), is formed as a milk inlet directly on the milk valve section, in such a way that when the milk container (4) is inserted, the milk snap-in valve (17) can be introduced into the complementary receiving section (17a) for the snap-in valve and is locked therein.

The invention relates to a device for the preparation of optionally cold or warm milk froth or the dispensing of optionally cold or warm milk according to the preamble of claim 1.

According to the prior art, coffee preparation devices, particularly espresso machines, are frequently equipped with milk froth preparation devices which comprise, as an essential component, a frothing device with a flow path embodied as a venturi nozzle. The flow path is connected to a milk conduit into which an air intake line or opening can lead for the preparation of milk froth. To prepare milk froth, steam is fed to the flow path of the frothing device embodied as a venturi nozzle from a steam generator of the coffee preparation device, by whose flow in the flow path low pressure is generated which suctions milk from a milk container via the milk conduit and air via the air duct. As a consequence, steam, milk and air are mixed in the flow path and frothed into warm milk froth. If the air supply is blocked, no froth is produced in the flow path of the frothing device, and only hot milk is prepared.

It is also known to prepare warm milk froth or warm milk beverages in a device by suctioning milk with a pump from a container and feeding it during suctioning through a flow heater, thus heating it, upon which it is conveyed via a restriction to an outlet (EP 1 593 330 A2). To prepare froth, air from an air supply line is mixed with the milk flowing through a suction line. To clean the flow heater and lines connected thereto, particularly the suction line and an outlet line to an outlet of the device, cleaning fluid can be fed from an external source via a cleaning valve into a segment of the suction line. Another valve with a collecting vessel or a discharge is arranged at the beginning of this segment of the suction line through which cleaning fluid or water can flow off from the suction line. However, a segment of the suction line adjacent to the milk container, which particularly protrudes from above into the milk container, cannot be rinsed, since the cleaning fluid must not flow into a milk container. This is prevented by at least one check valve in the suction line. This segment of the suction line must be removed from the milk container for rinsing and subjected to a separate rinsing process. The milk container can be switched out.

Recently, there is demand for devices for the preparation of milk froth which offer the possibility of not only producing warm milk froth but also dispensing cold milk froth. For this purpose, cold milk is pumped by means of a delivery pump from a reservoir to a frothing unit, and the air bringing about the frothing is either suctioned via an air supply line leading to a milk conduit, in which low pressure is formed as a result of the rate of flow of the milk, or the air is fed via an air conduit to the milk by means of high pressure generated by a pump. Mixture of the milk with the air can occur right in the milk conduit or later in a milk frothing device.

Moreover, it is known to optionally produce warm froth or cold froth in the same milk froth preparation device. To produce warm milk froth or even only warm milk, the milk conveyed by the pump or the milk/air mixture fed to the frothing device can be fed through a heat exchanger before or in the frothing device.

With such a known device for producing milk froth or milk beverages, in which milk is suctioned on demand from a container by means of a pump and conveyed to an outlet, and in which it is possible to mix air with the milk and process the resulting milk/air mixture in a cold or hot state into milk froth through a restriction, a provision is made to optionally convey the milk/air mixture directly or via a flow heater of the device to the outlet (WO 2008/083941 A1). Specifically, a milk inlet that connects the milk container to the cold-frothing device via a milk valve channel particularly has at least one segment of a milk suction line that reaches into the milk container. The milk suction line leads through a valve, with which it can be switched to another container, to a pump. An outlet line downstream from the pump has two parallel sections arranged between the restriction and the outlet and optionally actuated via a valve, with the flow heater being associated with only one of these parallel sections. In this way, cold or hot milk froth can be conveyed to the outlet. This device for producing milk froth or milk beverages can be embodied as an independent device or as a component of a coffee maker. The device can be cleaned in a manner similar to that described in EP 1 593 330 A2 mentioned above.

The object of the present invention is to provide a compact, robust and efficient device for optionally preparing cold or warm milk froth or delivering cold or warm milk which is characterized by less effort and optimum cleaning with a reduced need for cleaning.

This object is achieved with a device of the type mentioned at the outset with the features indicated in claim 1.

Accordingly, the invention is based on a device for the preparation of optionally cold or warm milk froth or the dispensing of optionally cold or warm milk which comprises a milk container that can be removed from the device, a milk inlet that connects the milk container via a milk valve channel to a cold-frothing device that can be activated via an air valve channel, an outlet line arranged downstream from the frothing device with an outlet and, as needed, optionally activatable means for heating the milk froth prepared in the frothing device or the milk flowing through the cold-frothing device. In particular, the cold-frothing device can have a restrictor section or restrictor through which the milk flows that is aerated in order to produce froth. The generation of froth can already begin downstream from the connection of the milk valve channel to the air valve channel. A pump, particularly a suction pump, can be provided for transporting the milk through the milk inlet, the milk valve channel and the cold-frothing device.

According to the invention, the milk container can be inserted in a guided manner in a certain position into the device for the preparation of optionally cold or warm milk froth or the dispensing of optionally cold or warm milk, and has on its bottom a milk plug valve. A complementary milk plug valve receptacle which fits this is permanently arranged as a milk inlet directly on the milk valve channel, i.e., a valve of the device, and embodied such that, upon insertion of the milk container, the milk plug valve is readily plugged into and locked in the complementary milk plug valve receptacle. The complementary milk plug valve receptacle is arranged in a stationary manner directly below the milk plug valve of the milk container.

The milk flow path from the milk container inserted into the device to the milk inlet of the milk valve channel is thus minimized. Particularly, no milk suction line or milk inlet line upstream from the milk inlet of the milk valve channel need be rinsed, removed from the milk container for this purpose and connected to an external cleaning fluid source such as a rinsing fluid container and then inserted again into the milk container. The hygienic condition of the milk path can thus be improved while simplifying the use of the device.

In order to precisely guide and position the milk container, the device for the preparation of optionally cold or warm milk froth or the dispensing of optionally cold or warm milk according to claim 2 comprises a housing base on which a milk container holding chamber is permanently arranged, and the milk container can be inserted from above into the milk container holding chamber such that the milk plug valve on the bottom of the milk container is inserted into the stationary complementary milk plug valve receptacle at the milk inlet directly against the milk valve channel or valve and engages therein. This ensures a secure, tight connection between the milk plug valve of the milk container and the complementary milk plug valve receptacle on the housing base of the device.

According to claim 3, the milk container holding chamber is especially expediently connected to the cold side of a Peltier element in a planar, thermally conductive manner, with the milk container resting tightly but detachably against the thermally conductive inner side of the milk holding container.

To supply the Peltier element with power, the housing base according to claim 14 can expediently have a power supply connection as well as a start contact that can be actuated by the insertable milk container with which the power supply of the Peltier element is activated when the milk container is inserted into the milk container holding chamber on the base. This ensures that the milk in the milk container is cooled largely automatically.

In a development of the device for the preparation of optionally cold or warm milk froth or the dispensing of optionally cold or warm milk, a rinsing fluid container is firmly arranged according to claim 4 on the housing base that is connected to the warm side of the Peltier element in a planar, thermally conductive manner, and a fluid container can be inserted in a guided manner into the rinsing fluid container holding chamber having on its bottom a fluid plug valve which is inserted into a complementary rinsing fluid valve receptacle when the rinsing fluid container is inserted into the rinsing fluid container holding chamber. The complementary rinsing fluid plug valve receptacle is connected in a fluid-conducting manner to a rinsing fluid inlet of a rinsing fluid valve channel in order to enable cleaning of the lines and components of the device downstream from the rinsing fluid valve channel as needed. Since the rinsing fluid is heated in an energetically favorable manner by the Peltier element used for the cooling of the milk container, the rinsing fluid can be expected to have a good rinsing and cleaning effect.

The thermally conductive connection of the Peltier element to the milk container holding chamber on the one hand and to the rinsing fluid container holding chamber on the other hand can be effectively achieved in a structurally simple manner by arranging the Peltier element according to claim 5 in a thermally conductive manner between the milk container holding chamber and the rinsing fluid container holding chamber.

In one especially compact embodiment of the device for the preparation of optionally cold or warm milk froth or the dispensing of optionally cold or warm milk, a manifold valve is arranged according to claim 6 in the housing base of the device which comprises the milk valve channel with the complementary milk plug valve receptacle at its milk inlet, an air valve channel, a manifold valve outlet and a rinsing fluid valve channel via which a rinsing fluid line can be added to the manifold valve outlet.

The manifold valve is particularly embodied such that, in a first position, it connects the manifold valve outlet to the milk inlet and the milk plug valve receptacle or, in a second position, it connects the manifold valve outlet to the milk inlet and the air inlet on an air feed line, whereby air is added to the milk by means of the low pressure occurring as a result of the flowing milk or under the action of the pump in order to generate milk froth. In a third position of the manifold valve, its manifold valve outlet is connected to its rinsing fluid inlet, whereby rinsing fluid is fed to the pump, the cold-frothing device, the outlet line and the outlet, since the pump and the cold-frothing device are arranged in terms of theft flow between the manifold valve outlet and the outlet line.

In a spatially favorable manner, besides the pump and the cold-frothing device, electrical drive members of the manifold valve and pump are arranged in the housing base according to claim 7 and, expediently according to claim 13, their internal control units as well.

Alternatively, the drive members can simply be controlled manually using a switching device.

In a development of the internal control units, they can, according to claim 15, have an interface to the wireless or wired connection to a central control unit in order to control the drive members of the manifold valve and the pump in a centralized manner, particularly using a control unit of a beverage preparation device.

In the device for the preparation of optionally cold or warm milk froth or the dispensing of optionally cold or warm milk, the cold-frothing device according to claim 8 can be embodied simply as a restrictor, particularly as a restrictor section.

In the device for the preparation of optionally cold or warm milk froth or dispensing of optionally cold or warm milk, the outlet on the outlet line according to claim 9 uniquely comprises, as an optionally activatable means for heating the milk froth prepared in the cold-frothing device of the device and the milk flowing through it, a steam-heating device with a steam generator coupling device embodied such that the outlet is capable therewith of heating cold milk froth and cold milk that is prepared in the cold-frothing device or dispensed from same through the feeding of steam from an external steam generator or a steam outlet line of the steam generator into the steam generator coupling device.

The device can prepare cold milk froth or dispense cold milk without connecting the steam generator coupling device to an external steam generator. For this purpose, the device can be used as an independently usable simple assembly. To operate the device as an independent device in the uncoupled state in which cold milk froth or cold milk can be dispensed from it, the steam generator coupling device can be locked, and it can particularly be locked automatically in an especially advantageous manner according to claim 10, when the steam generator coupling device is separated from an external steam generator or its steam line.

If the possibility of the optional preparation of warm milk froth or warm milk is desired, the steam generator coupling device is connected to an external steam generator or a steam outlet line in order to optionally activate the steam-heating device of the outlet by feeding in steam and thus heating the milk froth or the milk, which is then dispensed from the outlet. Since the heating of the milk froth or milk only takes place in the outlet, there are no heat losses in the outlet line. Consequently, no steam generator is provided in the device for the preparation of warm milk froth or warm milk; rather, in much less elaborate fashion, only the steam generator coupling device of the outlet of the device for coupling to the external steam generator or its steam outlet line is present which has a complementary steam generator coupling device.

In other words, the means for the preparation of warm milk froth or warm milk is complete if the steam generator coupling device is coupled directly or indirectly to an external steam generator outside of the independently usable device. To carry out the heating function, the steam generator coupling device is no longer blocked, but open.

According to claim 11, the outlet or its steam-heating device can be embodied in uncomplicated fashion as a mixer in which the cold milk froth that is fed in is mixed with the steam fed in by the steam generator coupling device, thus heating the mixture directly.

However, if the cold-prepared milk froth or the cold milk is not to come into direct contact with the heating steam in order to remain as unchanged as possible in its material composition during heating, instead of the embodiment as a mixer it is also possible according to claim 12 to embody the steam-heating device of the outlet as a heat exchanger heated by the externally generated steam through which the cold-prepared milk froth or the cold milk flows.

Especially advantageously, the separate device for the preparation of optionally cold or warm milk froth or the dispensing of optionally cold or warm milk is used according to claim 16 in conjunction with a beverage preparation device, particularly a coffee beverage preparation device, for which purpose the steam generator coupling device of the outlet of the device for the preparation of optionally cold or warm milk froth or the dispensing of optionally cold or warm milk is coupled with a steam outlet line of the steam generator of the beverage preparation device provided with a steam valve. When the steam generator coupling device is connected, the steam generator present in the beverage preparation device can also be used to produce warm milk froth or warm milk if the steam generator is switched on and the steam valve of the steam outlet line coupled with the device is opened in a controlled manner.

By feeding the steam produced using an external powerful steam generator through the steam generator coupling device into the steam-heating device of the outlet of the device for the preparation of optionally cold or warm milk froth or optionally cold or warm milk, the outlet can also sufficiently heat the milk froth generated from cold milk or the cold milk that was previously cooled.

The central control unit of the beverage preparation device expediently also controls a controllable steam valve in a steam outlet line of the steam generator of the beverage preparation device or the steam generator itself, with it being possible to connect the steam outlet line to the steam generator coupling device of the device for the preparation of optionally cold or warm milk froth or optionally cold or warm milk. When the steam generator coupling device is connected and the steam valve is open, the steam generator to which the steam outlet line is connected is efficiently used in the beverage preparation device for the preparation of warm milk froth or warm milk.

The connection of the steam generator coupling device to the steam outlet line of the beverage preparation device can also be performed indirectly via a conventional frothing device of the beverage preparation device.

An exemplary embodiment of the invention is explained below on the basis of a schematic drawing with one figure, from which the features of the invention can be seen.

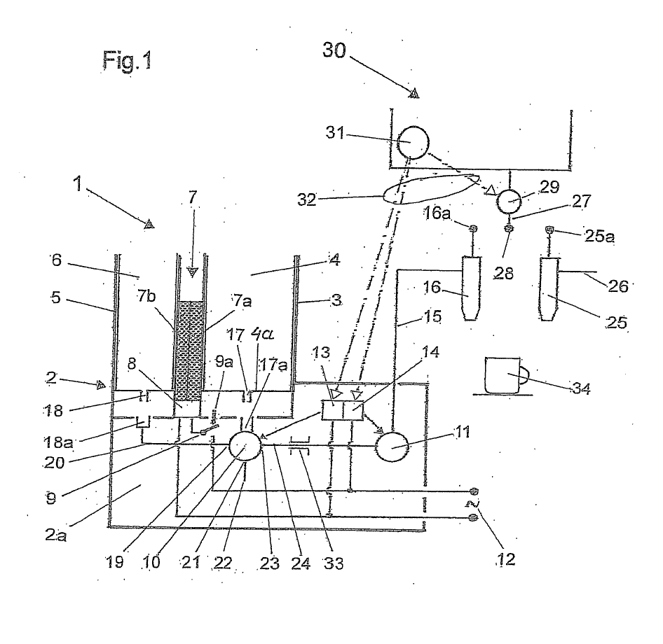

FIG. 1 shows a device for preparing optionally cold or warm milk froth or for dispensing optionally cold or warm milk in a state in which it is connected to a beverage preparation device in terms of control but in a fluidly disconnected state before the operating state.

In FIG. 1, the device for the preparation of optionally cold or warm milk froth or the dispensing of optionally cold or warm milk is generally designated by 1.

It comprises a housing unit 2 with a housing base 2a on which a milk container holding chamber 3 and a rinsing fluid container holding chamber 5 enclose a Peltier element 7 between them, so that a cold side 7a of the Peltier element is connected to the milk container holding chamber 3 in a planar, thermally conductive manner and rests against a warm side 7b of the Peltier element on a rinsing fluid container holding chamber 5 in a planar, thermally conductive manner. Otherwise, the milk holding container 3 is thermally isolated from the rinsing fluid container 6.

A milk container 4 can be inserted from above into the milk holding chamber 3 until it reaches a lower final position, over which the milk container 4 is shown in in FIG. 1. In the lower final position of the milk container 4, a milk plug valve 17, which is arranged in the bottom 4a of the milk container 4, protrudes into a complementary milk plug valve receptacle 17a, which functions directly as a milk inlet on a milk valve channel (not shown in FIG. 1) of the manifold valve 10.

The rinsing fluid container 6 is inserted from above into the rinsing fluid container holding chamber 5. On its bottom, the rinsing fluid container 6 has a rinsing fluid plug valve 18 which, in the lower final position (not shown in FIG. 1) of the rinsing fluid container 6, is plugged into and locked in a rinsing fluid plug valve receptacle 18a. A rinsing fluid line 20 leads from the rinsing fluid plug valve receptacle 18a to a rinsing fluid inlet 19 of the manifold valve 10.

The rinsing fluid container 6 rests against an inner side of the rinsing fluid container holding chamber 5, so that heat is transferred over a large surface from a Peltier element warm side 7b of the Peltier element 7 to the rinsing fluid container 6, which is heated along with its contents. Simultaneously, the cold side 7a of the Peltier element 7 becomes cold, and the milk container 4 is cooled along with its contents. As needed, the milk container 4 can be removed upward from the milk container holding chamber 3 and the rinsing fluid container 6 can be removed upward from the rinsing fluid container holding chamber 5.

The manifold valve 10 with the milk plug valve receptacle 17a acting as a milk inlet, with the rinsing fluid inlet 19, with an air inlet 21 that is connected to an air conduit 22, and with a manifold valve outlet 23 is permanently arranged in the housing base 2a of the housing unit 2.

A manifold valve outlet line 24 leads from the manifold valve outlet 23 to a pump 11 embodied as a suction pump, which is also firmly arranged in the housing base. A restrictor 33 is inserted into the manifold valve outlet line 24. The restrictor 33 has a function of preparing cold milk froth, when aerated milk is fed to it from the manifold valve 10 via the pump 11.

The housing base 2a further comprises electrical drive members (not shown) of the manifold valve 10 and pump 11 as well as internal control units 13 and 14 of the manifold valve 10 or of the pump 11, with which they can be adjusted and switched on.

To supply the Peltier element 7 with power, the housing base 2a has a power supply connection 12 which also supplies the control units 13, 14 for drive members of the manifold valve 10 and the pump 11 with power. The Peltier element 7 is only supplied with power in the state in which the milk container 4 cooled in the milk container holding chamber 3 is lowered to the final position through dosing of a start contact 9 by means of an actuating element 9a, which is embodied as a push rod in the present example.

With the Peltier element 7, milk that is precooled in a refrigerator can be additionally cooled in the milk container 4 inserted into the milk container holding chamber 3, with it being possible at the same time for rinsing fluid in the rinsing fluid container 6 that is inserted into the rinsing fluid container holding chamber 5 to be heated in order to achieve a good rinsing or cleaning effect.

An outlet line 15 is connected to a pressure outlet of the pump 11 in the housing base 2a which leads to an outlet 16 arranged outside of the housing base 2a. The outlet 16 comprises a steam-heating device that is connected to a lockable steam generator coupling device 16a.

The steam generator coupling device 16a can be coupled with a complementary steam generator coupling device 28 of a beverage preparation device 30, which can be charged with steam from a steam generator in the beverage preparation device 30 via a steam valve 35 of a steam line 34.

In the configuration of the device 1 according to FIG. 1, in which no external steam outlet line is connected to the steam generator coupling device 16a and the steam generator coupling device 16a is locked, the outlet 16 serves as a dispensing device for cold milk or cold milk froth.

In contrast, if the steam generator coupling device 16a is connected to the complementary steam generator coupling device 28 and is itself open and connected in a steam-conducting manner to the steam outlet line 27 with the steam valve 29 open, the hot steam produced in the steam generator of the beverage preparation device 30 can heat cold milk froth that was prepared in the device 1 and flows into the outlet 16 provided with the steam-heating device, or it can effectively heat cold milk directly or indirectly. On the other hand, in order to dispense cold milk froth or cold milk from the outlet 16, the steam valve 29 is closed.

The steam valve 29 in the steam outlet line 27 and the control units 13, 14 of the manifold valve 10 and the pump 11 are expediently controlled by a central control unit 31 of the beverage preparation device 30 via control connections 32, which can be embodied by lines or wirelessly and are indicated with broken lines in FIG. 1. For this purpose, the internal control units 13, 14 of the device 1 can have an interface through which they communicate via the control connections 32 with the external control unit 31.

The manifold valve 10 in the housing base 2a that can also be controlled by the central control unit 31 has, in addition to the milk plug valve receptacle 17a and the milk inlet, an air inlet 21 with the air conduit 22 and a rinsing fluid inlet 19 with the rinsing fluid line 20 which leads to the rinsing fluid plug valve receptacle 18a.

To start the device, after insertion of the milk container 4 into the milk container holding chamber 3, the plug valve 17 on the bottom of the milk container is plugged into the milk plug valve receptacle 17 as a milk inlet on the manifold valve 10 and locked. Moreover, as a result of the inserted milk container 4, the start contact 9 is closed by means of the actuating element 18a, namely by means of the push rod.

If the manifold valve 10 is then put into its first position by its control unit 13 and its drive member, the milk inlet or the milk plug valve receptacle 18a is connected to the manifold valve outlet 23, while the air inlet 21 and the rinsing fluid inlet 19 are blocked. The milk suctioned by the pump 11 is suctioned out of the manifold valve outlet 23 and the milk valve channel of the manifold valve 10 and fed to the outlet 15 as pure milk.

In contrast, if the manifold valve 10 is put into a second position by its drive member controlled by its control unit 13, the milk plug valve receptacle 17a or the milk inlet remains connected to the manifold valve outlet 23 and the air inlet 21 is opened, which is connected to the milk valve channel, also referred to as the milk flow path. As a result, besides the milk in the manifold valve 10 suctioned by the pump, air is also suctioned and added to the milk. The resulting milk/air mixture is further pumped by the pump 11 through the restrictor 33 arranged between the manifold valve outlet 23 and the outlet 16, which restrictor 33 is arranged upstream from the pump 11 in the present exemplary embodiment. The milk/air mixture compressed in the restrictor 33 expands downstream from the restrictor and milk froth is fed through the outlet line 15 to the outlet 16.

In a third position controlled by the control unit 13 and the drive member of the manifold valve 10, the milk plug valve receptacle 17a or the milk inlet and the air inlet 21 are blocked, while the rinsing fluid inlet 19 is open, and the rinsing fluid line 20 is connected via a rinsing fluid valve channel to the manifold valve outlet 23. On the assumption that rinsing fluid was previously introduced with the rinsing fluid container 6 into the rinsing fluid container holding chamber 5, whereby the rinsing fluid plug valve 18 was plugged into the rinsing fluid plug valve receptacle 18a and the rinsing fluid plug valve 18 was locked with the rinsing fluid plug valve receptacle 8a, the pump 11 suctions rinsing fluid through the manifold valve 10 and conveys the rinsing fluid through the manifold valve outlet line 23, the restrictor 33, the pump 11 and the outlet line 15 to the outlet 16.

In a variation of the device 1 for the preparation of milk froth, the valve positions of the manifold valve 10 and the operation of the pump 11 can also be selected manually independently of a beverage preparation device by means of the internal control units 13, 14 for the manifold valve 10 and the pump 11 via a switching arrangement (not shown).

As shown in FIG. 1, the outlet 16 of the device 1 does not need to be connected to an external steam outlet line 27 or a steam generator in order to prepare cold froth or to dispense cold milk. However, it can remain connected to the steam outlet line 27 in order to prepare cold froth or dispense cold milk if the steam outlet valve 29 is closed by the central control unit 31 or the steam generator is inactive.

On the other hand, in order to prepare warm milk froth or warm milk, the outlet 16 must be functionally connected via its steam generator coupling device 16a to a steam outlet line 27, for example, or to a steam generator, so that steam is fed in the present example from the steam outlet line 27 via the controlled steam outlet valve 29 to the outlet 16.

It is indicated in FIG. 1 that the outlet 16 of the device 1 can be connected with its steam generator coupling device 16a to the complementary steam generator coupling device 28 of the beverage preparation device 30 in place of a conventional frother 25 having a steam generator coupling device 25a and a frother milk conduit 26, which can only dispense hot milk.

The milk froth prepared or the milk dispensed according to the above method alternatives can be received by a collecting vessel under the outlet 16 or frother 25.

### List of Reference Symbols

1 device for the preparation of milk froth
2 housing unit
2a housing base
3 milk container holding chamber
4 milk container
4a bottom
5 rinsing fluid container holding chamber
6 rinsing fluid container
7 Peltier element
7a Peltier element cold side
7b Peltier element warm side
8 Peltier element power supply
9 start contact
9a actuating element (push rod)
10 manifold valve
11 pump
12 power supply connection
13 control unit manifold valve
14 control unit pump
15 outlet line
16 outlet
16a steam generator coupling device
17 milk plug valve
17a milk plug valve receptacle
18 rinsing fluid plug valve
18a rinsing fluid plug valve receptacle
19 rinsing fluid inlet
20 rinsing fluid line
21 air inlet
22 air conduit
23 manifold valve outlet
24 manifold valve outlet line
25 frother
26 frother milk line
27 steam outlet line
28 complementary steam generator coupling device
29 steam valve
30 beverage preparation device
31 central control unit
32 control connections
33 restrictor
34 collecting vessel

1. Device for preparing optionally cold or warm milk froth or for dispensing optionally cold or warm milk (1), comprising
a milk container (4) that can be removed from the device,
a milk inlet which connects the milk container (4) via a milk valve channel to a cold-frothing device that can be activated via an air valve channel,
an outlet line (15) arranged downstream from the cold-frothing device, with an outlet (16) and, as needed,
optionally activatable means for heating the milk froth prepared in the cold-frothing device or the milk flowing through the cold-frothing device,
characterized in that
the milk container (4) can be inserted in a guided manner into the device (1) and has on its bottom (4a) a milk plug valve (17),
that a complementary milk plug valve receptacle (17a) that is firmly arranged in the device (1) is embodied as a milk inlet directly at the milk valve channel such that,
upon insertion of the milk container (4), the milk plug valve (17) can be plugged into the complementary milk plug valve receptacle (17a) and can be locked therein.

2. Device as set forth in claim 1,
characterized in that
the device (1) comprises a housing base (2) on which a milk container holding chamber (6) is permanently arranged, and
the milk container (4) can be inserted from above in a guided manner into the milk container holding chamber (6) such that the milk plug valve (17) on the bottom (4a) of the milk container (4) is plugged into the complementary milk plug valve receptacle (7a) and engages therein.

3. Device as set forth in claim 2,
characterized in that
the milk container holding chamber (3) is connected in a planar, thermally conductive manner to the cold side (7a) of a Peltier element (7) and
the milk container (4) rests tightly but detachably against a thermally conductive inner side of the milk container holding chamber (3).

4. Device as set forth in claim 3,
characterized in that
a rinsing fluid container holding chamber (5) is permanently arranged on the housing base (2) and is connected in a planar, thermally conductive manner to the warm side (7b) of the Peltier element (7),
a rinsing fluid container (6) having a rinsing fluid plug valve (18) on its bottom can be inserted in a guided manner into the rinsing fluid container holding chamber (5) such that the rinsing fluid plug valve (18) can be plugged into a complementary rinsing fluid plug valve receptacle (18a) that is connected in a fluidly conductive manner to a rinsing fluid inlet (19) of a rinsing fluid valve channel.

5. Device as set forth claim 4,
characterized in that the Peltier element (7) is arranged in a thermally conductive manner between the milk container holding chamber (3) and rinsing fluid container holding chamber (6).

6. Device as set forth in claim 1,
characterized in that
a manifold valve (10) is arranged in the housing base (2a) which comprises the milk valve channel with the complementary milk plug valve receptacle (17a) at its milk inlet, an air valve channel, a manifold valve outlet (23) and a rinsing fluid valve channel via which a rinsing fluid line (20) can be connected to the manifold valve outlet (23).

7. Device as set forth in claim 6,
characterized in that
the cold-frothing device and a pump (11) are arranged in terms of flow in the housing base (2a) between the manifold valve outlet (23) and an outlet line (15) and
that electrical drive members of the manifold valve (10) and pump (11) are arranged in the housing base (2a).

8. Device as set forth in claim 1,
characterized in that
a restrictor (33) is provided as a cold-frothing device.

9. Device as set forth in claim 1,
characterized in that
the outlet (16) comprises a steam-heating device with a lockable steam generator coupling device (16a) with which the outlet (16) is capable of heating cold milk froth prepared in the cold-frothing device or milk flowing out of it.

10. Device as set forth in claim 9,
characterized in that
the steam generator coupling device (16a) is embodied so as to be automatically lockable in the uncoupled state.

11. Device as set forth in claim 9,
characterized in that
the outlet (16) has, as a steam-heating device, a mixing device for mixing the milk froth flowing out of the cold-frothing device or the milk with steam.

12. Device as set forth in claim 9,
characterized in that
that the outlet (16) has, as a steam-heating device, a steam-heated heat exchanger.

13. Device as set forth in claim 7,
characterized in that
internal control units (13, 14) of the electrical drive members of the manifold valve (10) and pump (11) are arranged in the housing base (2a).

14. Device as set forth in claim 7,
characterized in that
a power supply connection (39) as well as a start contact (9) that can be actuated by the insertable milk container (4) are arranged in the housing base (2a) with which a power supply of the Peltier element (7) can be activated.

15. Device as set forth in claim 13,
characterized in that
the internal control units (13, 14) have an interface to the wireless or wired connection to a central control unit (31).

16. Beverage preparation device, particularly a coffee beverage preparation device with a steam generator, which comprises a device (1) for the preparation of optionally cold or warm milk froth or optionally cold or warm milk as set forth in claim 1, characterized in that
the steam generator coupling device (16a) of the device (1) can be connected to a steam outlet line (27) of the steam generator provided with a controllable steam valve (29).

17. Beverage preparation device as set forth in claim 15,
characterized in that
the central control unit (31) is a component of the beverage preparation device (30), and that an actuating device of the steam valve (29) is connected to the central control unit (31).
